(19) United States
(12) Patent Application Publication
(10) Pub. No.: US 2012/0248755 A1
(43) Pub. Date: Oct. 4, 2012

(54) DUAL-VALUE MAGAZINE REWARD CARD

(76) Inventor: John C. Mulcahy, Summit, NJ (US)

(21) Appl. No.: 13/078,215

(22) Filed: Apr. 1, 2011

(51) Int. Cl. B42D 15/00

(52) U.S. Cl. 283/56

(57) ABSTRACT

A dual-value magazine voucher is provided, wherein said voucher has a first and second value. Said first value is a magazine subscription value redeemable for the full retail value of one or more magazine subscriptions, and said second value is a lesser cash value, redeemable for a cash-refund of the full cash value. Said cash value is lower than said magazine subscription value.

### FIELD OF THE INVENTION

The present invention relates to a dual-value Magazine Gold Card (MGC) that can be redeemed in full for one or more magazine subscriptions selected from a broad list of titles at varying price points or alternatively redeemed for a low fixed cash-value. Subscriptions acquired with the MGC can be represented on the Audit Bureau of Circulations (ABC) Publisher's Audit Statement as paid for by the individual subscriber.

### BACKGROUND OF THE INVENTION

Stored-value cards are a standard form for gifts, store credit, and reward programs and other marketing tactics. For a purchase price, return credit, or as some form of reward or marketing incentive, consumers are given a card or voucher with a fixed value that can be used to purchase goods or services (the terms “card” and “voucher” are used interchangeably herein, and it should be understood that both terms are inclusive of the other.) These cards can come in various forms that limit the usage, such as limits to particular items, services, stores, or dates. However, a standard feature of such stored-value cards and vouchers is that they cannot be redeemed for cash. The inability to redeem such cards for cash has been a critical problem and a hindrance to making any such cards successful in the magazine industry, where publishers cannot count subscriptions gathered with these cards as paid circulation. This paid circulation status is extremely important to publishers in terms of reportable sales, reportable subscriptions, and consequent ability to produce advertising revenue.

Reward programs, and other various magazine marketing techniques have previously been coupled with free subscription offers to consumers for one or more free magazine subscriptions directly or through the redemption of a voucher. However, all previous offers which have offered one or more complete magazine subscriptions have had no cash redemption value, and have been only redeemable for magazine subscriptions. The inability of consumers to redeem these offers for cash has caused any such subscription to be treated differently by the auditing body of the magazine industry, the Audit Bureau of Circulations (ABC), as these subscriptions are not counted as paid circulation. However, if the consumer has the option to redeem the card for a cash value, and the consumer chooses to elect to receive one or more magazine subscriptions instead of cash, such subscriptions can then be considered as purchased for value, and are counted as paid circulation by ABC.

In the patent application U.S. 2009/00633414 (Clarke), the applicant proposed a method for consumers to purchase a transferable stored value card that is redeemable for a set value in cash or merchandise in order to solve the above shortcoming with such stored-value cards. Clarke, however, is simply a purchased value card, that can be redeemed for that same purchased value as merchandise or cash. Essentially, such a card is simply a gift card that allows for a cash refund of the same value.

Similarly, U.S. Pat. No. 6,834,796 (Anvekar) allows for cash redemption, but similar to Clarke, the cash redemption is based on the stored-value remaining on the card. In particular, Anvekar focuses on the anonymous redemption of any stored value remaining on a card. In short, Consumer-purchased stored-value cards in the prior art have one-value that either (1) has no cash value, and the stored-value is redeemable for specific goods or services only, or (2) has one value, that is redeemable towards specific goods or services or alternatively, the exact same value in cash, such as disclosed by Clark and Anvekar.

The MGC of the present intention allows the consumer (The “MGC-holder”) the option to choose a complete free magazine subscription (or subscriptions) from a wide array of magazines, and at the same time, also gives the consumer the alternate choice to exercise a small cash redemption option at a cash price considerably less than the perceived value of any subscription which might be chosen. This alternative cash redemption option allows the publisher to classify all subscriptions gathered under MGC offers as individually paid, but due to the lower cash value, provides an incentive for the MGC-holder to choose a free magazine subscription instead of redemption for a cash value.

This unique new method of offering consumers the choice of a complete subscription to an array of magazines on the one hand, and an alternative to choose a small cash redemption on the other, has been specifically reviewed and approved by ABC, which has ruled that each consumer who chooses to opt for a magazine subscription rather than the cash redemption is in effect paying for their subscription by declining to exercise their cash redemption option. This ABC approved dual-value solution makes MGC offers very desirable to publishers.

As disclosed in Clarke, there have also been previous magazine stored value card offers which have offered a cash redemption option, but such offers do not offer consumers a completely free magazine subscription of higher retail value then than the cash-redemption value. Instead, these previous magazine stored value cards have always been offered for a certain dollar amount towards a subscription, and the cash redemption option has been for this exact same amount.

These prior attempts have not been effective in the marketplace because either the value is too high, and the consumer is likely to redeem the offer for cash, not towards a magazine subscription, or the value is too low, and does not cover the cost of a subscription, and the consumer must add additional funds out-of-pocket to get a subscription. In either case, consumers are less likely to choose the subscription option.

First, where the value of the card is high enough to pay for most or all of the subscription offered, the card also has a correspondingly higher cash redemption amount. This has inevitably caused a high percentage of consumers to opt for cash redemption instead of a magazine subscription. There is little to no added incentive for the consumer to redeem the card for a subscription instead of cash when the cash value matches the subscription value. This limits the amount of individually paid subscriptions generated from such programs. Further, this also increases the effective cost of any such program. Since such a high percentage will be redeemed for cash, merchants are always required to pay a price much closer to the face value of the card, thus leaving less of a profit margin than other stored value cards they might choose to offer instead.

The present invention solves this problem by offering a complete subscription to a wide variety of sought after magazines or in the alternative, a low cash redemption option (usually $5.00). Because the subscription option has more value than the cash option, it is much more attractive to the consumer, and the overwhelming majority of consumers are likely to choose the subscription option over cash redemption. This results in (1) more individually paid subscriptions being gathered with the present invention than through previous offers, and (2) the MGC of the present invention can be made available to marketers at a much lower price than previous offers (at a price at or less than the cash redemption option). This very low price vs. the higher perceived value makes the offer more attractive to merchants and other organizations that are looking for incentives and rewards to offer consumers.

Second, if the prior stored value card has a value low enough to discourage cash redemption, the amount is also likely to not be high enough to cover the full cost of a subscription. This makes these offers unattractive to the merchant or organization offering the card and to the consumer as well. This partial credit towards a subscription is correctly perceived as a lesser value than other stored value cards on the market. The card is less attractive because it is for a low amount and because it covers only part of the cost of the subscription, and further, consumers must now provide credit card or payment information and pay a portion of the subscription cost out-of-pocket.

This has a negative impact on consumers, who are hesitant to provide personal financial information when avoidable for fear of fraud and/or unwanted subscription renewals, and a negative impact on merchants who do not wish to collect such information and take on the privacy and confidentiality burdens that follow. This leads to consumers being less willing to choose the subscription option, and has often led to merchants and others who offer such cards, deciding not to offer a magazine stored value card offer at all—instead opting for other stored value cards where no credit card or payment information is required.

The present invention issues an MGC that is good for one or more full subscriptions, and the MGC-holder never has to pay additional funds from their own money to cover the cost, and therefore when redeeming the MGC for a subscription, no financial information need be exchanged at any time in the transaction—the MGC will always cover the full subscription price.

The MGC eliminates traditional restraints that inhibited the ability of companies to make magazine subscriptions available to their consumers as premium and incentive items. The present invention opens up a new distribution channel for publishers to acquire paid subscribers and allows marketers to use the appeal of magazines in rewarding and motivating their customers and employees.

The MGC of the present invention is more attractive to merchants and other organizations offering these magazines to consumers because:
a) it can be offered to the merchant or organization at a much lower price (equal to or below the very low cash redemption option price);
b) it allows the merchant or organization to present consumers a stored value card with a relatively high perceived value since they are getting a complete subscription with no need to pay any additional amount towards the subscription; and
c) the merchant or other organization offering the MGC never needs to collect payment information from consumers, and there is never any residual value once the card is redeemed for either a complete subscription or the cash redemption option (the card is completely used up and expires as soon as it is redeemed).

The MGC of the present invention is more attractive to consumers because:
a) it has a higher perceived value than previously offered stored value cards applicable towards magazine subscriptions since the MGC is good for a complete subscription to the consumer's choice from among a wide variety of magazines with no extra payment required; and
b) The consumer need never give any credit card or payment information—only the name and address where the subscription is to be sent.

### SUMMARY OF THE INVENTION

According to the present invention, a dual-value Magazine Gold Card (MGC) is offered as a marketing incentive and/or rewards program. It should be understood that the MGC can be a standard physical card with a unique identification, similar to a standard gift card or credit card, or the MGC can be an electronic voucher with a unique identification. The MGCs are purchased by any company or organization to be offered as incentives and rewards to the company's or organization's consumers or participants. The present invention, by offering a separate redeemable cash value, will allow any subscriptions generated as a result of these rewards to be counted as paid circulation by ABC.

Each MGC will have two set values. The first value will be a fixed cash value, and the second value will be a magazine subscription value of greater retail value than the cash value.

An MGC-holder will have two redemption options, either redeeming the card for one or more full magazine subscriptions or redeeming the card for a lesser cash value. The stored-cash value allows the subscriptions to be counted as paid circulation by ABC, however since the stored cash value will be less than the subscription's retail value, the consumer will have an incentive to select subscriptions instead of the cash redemption.

The MGC will serve the traditional function of providing rewards and marketing incentives, benefiting both the company or organization offering the reward as well as the magazine subscription provider (the publisher). The MGC will also enhance the value of such rewards beyond the traditional value by providing a more versatile and enticing incentive reward that includes the option of a cash rebate, as well as providing greater advantage to the magazine publishers who can use MRC-based subscriptions to increase their paid circulation numbers.

### BRIEF DESCRIPTION OF THE DRAWINGS

FIG. 1 is a flow diagram overview according to the preferred embodiment of the present invention

FIG. 2 is an example of a redeemable MGC voucher

### DETAILED DESCRIPTION OF THE DRAWINGS

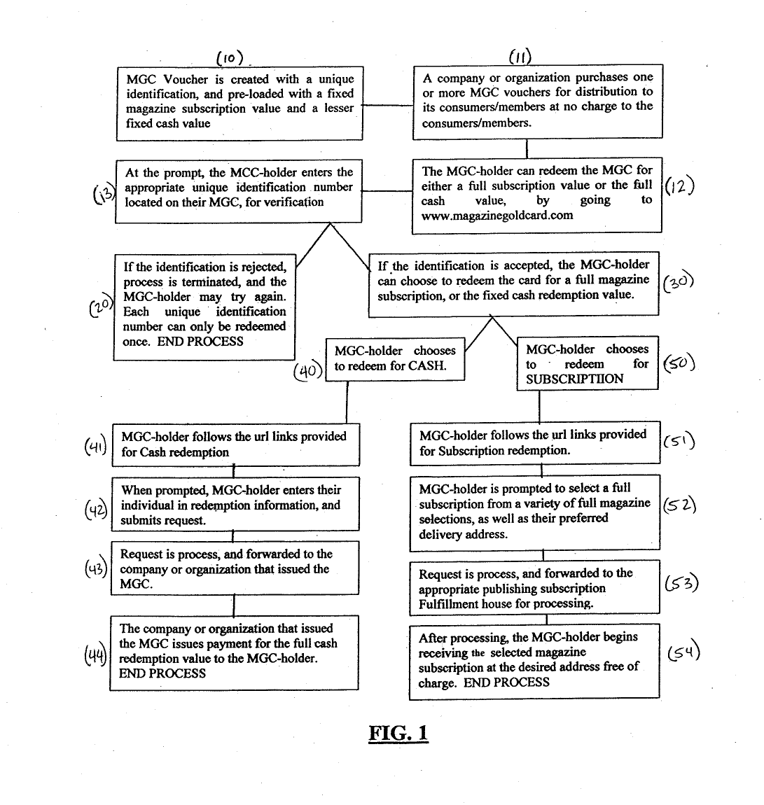

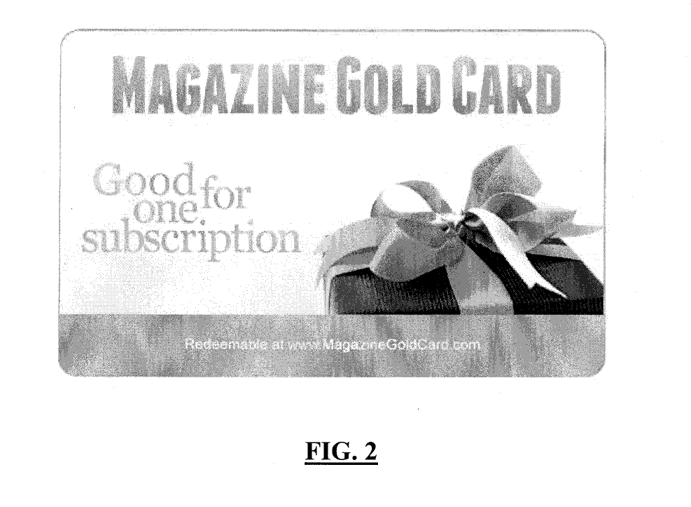

FIG. 2 shows one embodiment of the MGC that would be provided to potential consumers, and redeemed as outlined in the flow diagram of FIG. 1.

Initially, (10) an MGC voucher is created with a unique identification number, and a fixed subscription value (typically one full subscription for a magazine) as well as a cash redemption value (typically $5.00). (11) A company or organization can then purchase the MGC voucher at a premium rate, generally at or near the cash redemption value of each MGC voucher, and them distribute the MGC vouchers to their customers or members (whom are now “MGC-holders”).

Next, (12) the voucher has information directing the MGC-holder to redeem the MGC voucher, typically through the website www.magazinegoldcard.com, where (13) the MGC-holder is prompted to provide the unique identification number on the MGC voucher for verification. If verification fails (20), the MGC-holder is prompted to retry, however, vouchers can only be redeemed once, and an attempt to verify an already redeemed voucher will fail, and the process is ended. If verification is accepted (30), the MGC-holder is prompted to choose between the cash or subscription redemption options.

If the MGC-holder elects the cash option (40), the appropriate links on the website are followed (41), until the user is prompted to enter and submit their cash redemption information (42), which may include financial information if the MGC-Holder wishes to have an electronic transfer, or a mailing address for payment by check. The request and information is processed and forwarded to the company or organization that issued that specific MGC voucher (43), and the company or organization issues payment for the full cash-redemption value (44).

Alternatively, if the MGC-holder elects the subscription option (50), the appropriate links on the website are followed (51), until the user is prompted to select a full magazine subscription of their choice from a variety of selections and to enter their preferred delivery address (52). The request and information is processed and forwarded to the appropriate subscription Fulfillment House for the selected magazine publication for processing (53), and after processing the MGC-holder begins receiving the selected subscription and their desired address (54).

What is claimed is:

1. A dual-value magazine voucher, having a first and second value, wherein said first value is a magazine subscription value redeemable for the full retail value of one or more magazine subscriptions, and said second value is a cash value, redeemable for a cash-refund of the full cash value, wherein said cash value is lower than said magazine subscription value.
